(19) United States
(12) Patent Application Publication
(10) Pub. No.: US 2023/0096623 A1
(43) Pub. Date: Mar. 30, 2023

(54) SYSTEMS AND METHODS FOR VISION DIAGNOSTICS

(71) Applicant: INTELLIGENTDX LLC, Ventura, CA (US)

(72) Inventors: Tom S. Chang, Pasadena, CA (US); Nathan Lowry, Malden, MA (US)

(21) Appl. No.: 17/934,447

(22) Filed: Sep. 22, 2022

Related U.S. Application Data
(60) Provisional application No. 63/248,323, filed on Sep. 24, 2021.
(60) Provisional application No. 63/299,873, filed on Jan. 14, 2022.

(51) Int. Cl. G06T 7/00; G06V 10/766; G06V 10/44; G06V 10/764; G06V 40/18; G06T 7/60

(52) U.S. Cl. CPC G06T 7/0016; G06V 10/766; G06V 10/44; G06V 10/764; G06V 40/193; G06T 7/60; G06T 2207/10101; G06T 2207/30041

(57) ABSTRACT

Systems and methods for improved vision diagnostics are disclosed. Some embodiments relate to machine learning models for the analysis of vision diagnostics data. Some embodiments relate to improved, robust regression methods that can be used with vision diagnostics data to detect trends that may warrant medical intervention.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

This application claims the benefit under 35 U.S.C. § 119(e) to U.S. Provisional Patent Application No. 63/248,323, filed Sep. 24, 2021, and U.S. Provisional Patent Application No. 63/299,873, filed Jan. 14, 2022, the contents of which are incorporated herein by reference in their entirety and for all purposes.

### BACKGROUND OF THE INVENTION

### Field

The present application relates to systems, methods, and devices for determining and/or assisting with the monitoring and/or diagnosis of glaucoma and other conditions that cause vision loss in patients.

### SUMMARY

Accurate tracking of patient eye health over time is important for the early detection of conditions that may lead to permanent vision loss or that may indicate a patient is suffering from other serious health issues such as cancer or stroke. However, providers may encounter difficulty monitoring a patient's vision health over time and may struggle to identify changes in vision that may be cause for concern. Providers may also fail to consider or be aware of other health factors that may impact a patient's vision.

The present disclosure relates to systems and methods for monitoring, diagnosing, and preventing vision loss. The disclosures herein may result in earlier detection of conditions such as progressive glaucoma and the growth of tumors, leading to improved patient outcomes.

For purposes of this summary, certain aspects, advantages, and novel features are described herein. It is to be understood that not necessarily all such advantages may be achieved in accordance with any particular embodiment. Thus, for example, those skilled in the art will recognize that the disclosure herein may be embodied or carried out in a manner that achieves one advantage or group of advantages as taught herein without necessarily achieving other advantages as may be taught or suggested herein.

In some aspects, the techniques described herein relate to a method for regression fitting including: receiving, by a computing system, a dataset corresponding to a diagnostic test; receiving, by the computing system, one or more regression fitting parameters including a kernel; determining, by the computing system, an initial regression; calculating, by the computing system using a kernel, a plurality of local statistics of the dataset, the local statistics determined at least in part based on the one or more regression fitting parameters; determining, by the computing system, a plurality of envelopes, the plurality of envelopes based at least in part on the one or more regression fitting parameters and the plurality of local statistics; excluding, by the computing system, one or more data points of the dataset that are outside the plurality of envelopes; determining, by the computing system, a second regression based on the dataset, wherein the second regression excludes the one or more data points that are outside the plurality of envelopes.

In some aspects, the techniques described herein relate to a method, wherein the dataset includes retinal nerve fiber layer thickness data.

In some aspects, the techniques described herein relate to a method, further including: determining a rate of change of the retinal nerve fiber layer.

In some aspects, the techniques described herein relate to a method, wherein the dataset includes intraocular pressure data.

In some aspects, the techniques described herein relate to a method, wherein the dataset includes visual field data.

In some aspects, the techniques described herein relate to a method, wherein the kernel is a compact kernel.

In some aspects, the techniques described herein relate to a method, wherein the kernel is a non-compact kernel.

In some aspects, the techniques described herein relate to a method, wherein the one or more regression fitting parameters include a window size, and wherein the local statistics include a variance for each window of a plurality of windows.

In some aspects, the techniques described herein relate to a method, wherein the window size includes a number of days.

In some aspects, the techniques described herein relate to a method, wherein the window size includes a number of visits.

In some aspects, the techniques described herein relate to a method, further including: before receiving the dataset corresponding to a diagnostic test, receiving at least one optical coherence tomography image; determining, using an image classification image, a quality of each of the at least one optical coherence tomography image; and determining, using a feature extraction engine, a retinal nerve fiber layer thickness associated with each of the at least one optical coherence tomography image.

In some aspects, the techniques described herein relate to a system for regression fitting including: a computer readable storage medium having program instructions embodied therewith; and one or more processors configured to execute the program instructions to cause the system to: receive a dataset corresponding to a diagnostic test; receive one or more regression fitting parameters; determine an initial regression; calculate, using a kernel, a plurality of local statistics of the dataset, the local statistics determined at least in part based on the one or more regression fitting parameters; determine a plurality of envelopes, the plurality of envelopes based at least in part on the one or more regression fitting parameters and the plurality of local statistics; exclude one or more data points of the dataset that are outside the plurality of envelopes; determine a second regression based on the dataset, wherein the second regression excludes the one or more data points that are outside the plurality of envelopes.

In some aspects, the techniques described herein relate to a system, wherein the dataset includes retinal nerve fiber layer thickness data.

In some aspects, the techniques described herein relate to a system, wherein the instructions are further configured to cause the system to determine a rate of change of the retinal nerve fiber layer.

In some aspects, the techniques described herein relate to a system, wherein the kernel is a compact kernel.

In some aspects, the techniques described herein relate to a system, wherein the kernel is a non-compact kernel.

In some aspects, the techniques described herein relate to a system, wherein the one or more regression fitting parameters include a window size, and wherein the local statistics include a variance for each window of a plurality of windows.

In some aspects, the techniques described herein relate to a system, wherein the window size includes a number of days.

In some aspects, the techniques described herein relate to a system, wherein the window size includes a number of visits.

In some aspects, the techniques described herein relate to a system, wherein the instructions are further configured to cause the system to: before receiving the dataset corresponding to a diagnostic test, receive at least one optical coherence tomography image; determine, using an image classification image, a quality of each of the at least one optical coherence tomography image; and determine, using a feature extraction engine, a retinal nerve fiber layer thickness associated with each of the at least one optical coherence tomography image.

In some aspects, the techniques described herein relate to a system for determining a quality of an optical coherence tomography image, the system including: one or more computer data stores configured to store a plurality of computer executable instructions; and one or more hardware computer processors in communication with the one or more computer data stores and configured to execute the plurality of computer executable instructions in order to cause the system to: electronically access an optical coherence tomography image; determine, using an image classification engine, whether the optical coherence tomography image is suitable for feature extraction, wherein determining whether the optical coherence tomography image is suitable for feature extraction includes determining an indicator of the quality of the optical coherence tomography image; extract, using a feature extraction engine, a retinal nerve fiber layer thickness from the optical coherence tomography image; provide, by the system to a user of the system, the indicator of the quality of the optical computing tomography image and the retinal nerve fiber layer thickness.

In some aspects, the techniques described herein relate to a method for training an optical coherence tomography image analysis model, the method including: accessing, by a computing system, a set of optical coherence tomography images; accessing, by the computing system, one or more model training parameters; applying, by the computing system, an optical computing tomography image analysis module including an image classification model and a feature extraction model which is configured to, for each image in the set of optical coherence tomography images, determine a quality of the image and extract from the image a thickness of a retinal nerve fiber layer, wherein the computing system includes one or more hardware computer processors in communication with one or more computer readable data stores and configured to execute a plurality of computer executable instructions.

In some aspects, the techniques described herein relate to a method, wherein training the optical coherence tomography image analysis model includes using unsupervised learning.

In some aspects, the techniques described herein relate to a method, wherein training the optical coherence tomography image analysis model includes using supervised learning.

In some aspects, the techniques described herein relate to a computer-implemented method of training a machine learning model for condition identification including: accessing, by a computer system, a first plurality of demographic data from a first database; accessing, by the computer system, a second plurality of medical history data from a second database; accessing, by the computer system, a third plurality of optical testing data from a third database; creating, by the computer system, a training set based on the first plurality of demographic data, the second plurality of medical history data, and the third plurality of optical testing data; and training the machine learning model using the first training set, wherein the computing system includes one or more hardware computer processors in communication with one or more computer readable data stores and configured to execute a plurality of computer executable instructions. 54519939 56316475

All of these embodiments are intended to be within the scope of the present disclosure. These and other embodiments will become readily apparent to those skilled in the art from the following detailed description having reference to the attached figures, which are intended to illustrate but not to limit the present disclosure.

### BRIEF DESCRIPTION OF THE DRAWINGS

A better understanding of the systems, methods, and devices described herein will be appreciated upon reference to the following description in conjunction with the accompanying drawings, wherein:

FIG. 1 is a block diagram that illustrates training, validating, and tuning a machine learning model according to some embodiments.

FIG. 2 is an example of scoring OCT images according to some embodiments.

FIG. 3 is a block diagram that illustrates determining image quality and features using machine learning models according to some embodiments.

FIG. 4 is a plot that illustrates an example of retinal nerve fiber velocity.

FIG. 5 is a plot that illustrates an example of regression fitting.

FIG. 6 is a block diagram that illustrates performing a regression according to some embodiments.

FIG. 7 illustrates plots of intraocular pressure and RNFL thickness over time.

FIG. 8 illustrates regions of the eye.

FIG. 9 illustrate RNFL thicknesses as measured over time in different regions of the eye.

FIG. 10 is a block diagram depicting an embodiment(s) of a computer hardware system configured to run software for implementing one or more embodiments of systems, devices, and methods described herein.

### DETAILED DESCRIPTION

Although several embodiments, examples, and illustrations are disclosed below, it will be understood by those of ordinary skill in the art that the inventions described herein extend beyond the specifically disclosed embodiments, examples, and illustrations and includes other uses of the inventions and obvious modifications and equivalents thereof. Embodiments of the inventions are described with reference to the accompanying figures, wherein like numerals refer to like elements throughout. The terminology used in the description presented herein is not intended to be interpreted in any limited or restrictive manner simply because it is being used in conjunction with a detailed description of certain specific embodiments of the inventions. In addition, embodiments of the inventions can comprise several novel features and no single feature is solely responsible for its desirable attributes or is essential to practicing the inventions herein described.

As mentioned briefly above and as will now be explained in more detail, this application describes systems, methods, and devices for determining and/or assisting with the monitoring, diagnosis, and prevention of vision loss.

In some embodiments, the systems and methods described herein may be executed on a computer system operated by a provider of eyecare services, which may be located at the provider's office or at a remote location such as, for example, a data center. In some embodiments, a vendor may make the systems and methods described herein available via a software as a service model, a platform as a service model, and so forth. For example, users of the systems and methods described herein may access the systems and methods by way of a web browser, Electron application, native application, and so forth, which may be in communication with one or more remote systems. In some embodiments, a provider may transfer data to a system for analysis. In some embodiments, the provider may perform analysis on a local system, for example if the provider does not have access to a sufficiently fast or reliable internet connection. In some embodiments, the systems and methods described herein may be deployed on a cloud platform such as, for example, Google Cloud Platform, Amazon Web Services, Microsoft Azure, and/or the like.

Providers may use a variety of approaches to detect and diagnose glaucoma and other conditions that result in vision loss. However, these approaches are prone to significant problems that arise from measurement errors, analysis errors, or lack of sufficient patient history. These problems may make it difficult to, for example, differentiate between non-progressive and progressive glaucoma or to identify whether a patient has ocular hypertension.

### Example Machine Learning Training Embodiments

As described in greater detail below with reference to specific applications, machine learning or artificial intelligence models (hereinafter referred to as “models,” “ML models,” “AI models,” or “AI/ML models”) can be used to aid in analyzing data, determining trends, identifying related health conditions and/or demographic factors, and so forth. Such applications can enable earlier detection of conditions that can lead to permanent vision loss or other vision problems. Often, early detection can be difficult because data can be sparse, unreliable, or both. Identifying other conditions or demographic factors that can lead to or be correlated with vision problems can be difficult as providers have only limited time to review patient histories, may not have complete or accurate patient history, and so forth. Additionally, it can be difficult or impossible to identify other conditions, drug interactions, and so forth when considering one patient in isolation, causing providers to fail to recognize all but the most well-known interactions, co-morbidities, and/or the like. In some cases, an ML model can be deployed to determine previously unknown links between vision conditions and other factors.

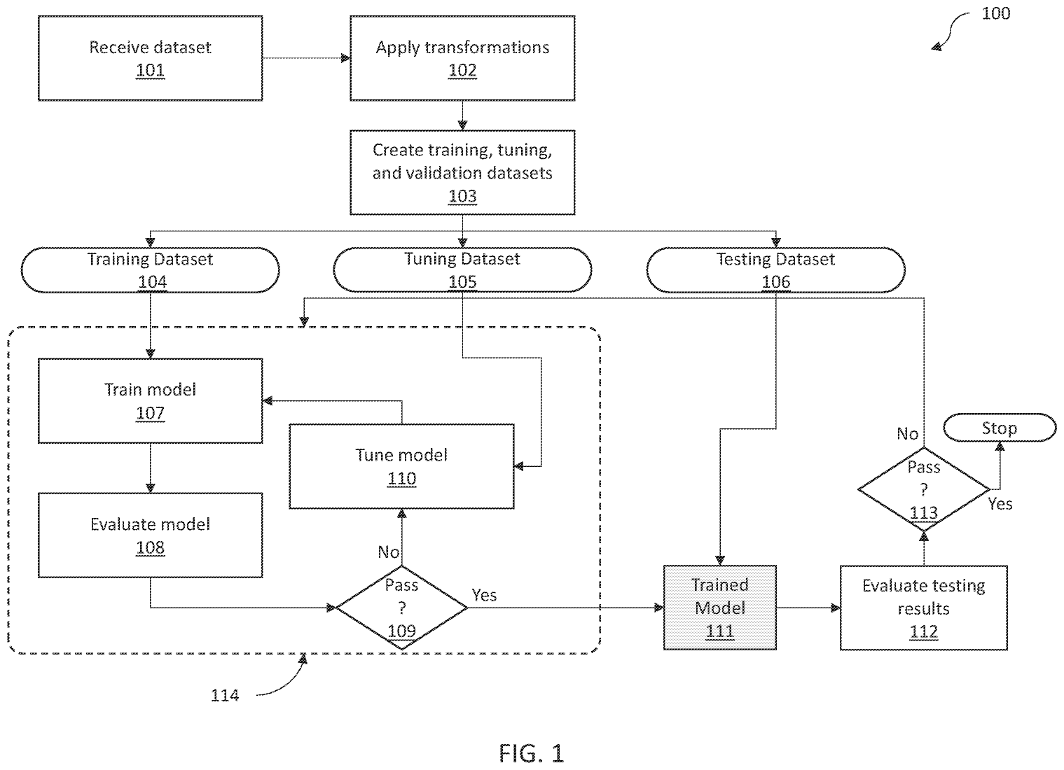

FIG. 1 depicts a flow chart for training an artificial intelligence or machine learning model according to some embodiments. The training process depicted in FIG. 1 can be used for training models to be used in a variety of applications as mentioned above. The training process can be run on a computing system. For example, the training process 100 can be used to train a model to determine image quality, extract features from images, project changes in clinically relevant parameters, identify relationships between different conditions, demographics, etc., and so forth.

At block 101, the system can receive a dataset that includes various information for use in training a model, such as optical coherence tomography (OCT) image data, electronic medical record data, visual field test data, intraocular pressure data, and so forth, as described in more detail below. At block 102, one or more transformations may be performed on the data. For example, data may require transformations to conform to expected input formats, for example to conform with expected date formatting, units (e.g., pounds vs. kilograms, Pascal, Torr, and mmHg, etc.), and so forth. Typically, data may be transformed or normalized before being used for machine learning training (or, after the ML model is trained, before running data through the model). For example, categorical data may be encoded in a particular manner. Nominal data may be encoded using one-hot encoding, binary encoding, feature hashing, or other suitable encoding methods. Ordinal data may be encoded using ordinal encoding, polynomial encoding, Helmert encoding, and so forth. Numerical data may be normalized, for example by scaling data to a maximum of 1 and a minimum of 0 or −1. Image data can undergo various transformations. For example, a channel value may be converted from a 0-255 range to a 0-1 range, image resolution can be set to standardized values, etc. For example, in the case of OCT data, it can be important to transform data into a standardized format regardless of the type of machine used to collect the data. In some embodiments, block 102 can include deduplication, editing or creating metadata, and so forth. In some embodiments, preparing the dataset at block 102 can include one or more manual steps. For example, a practitioner or other qualified individual may review part or all of the dataset, and they may annotate the dataset with relevant information for training the ML model, such as indicating which images are of suitable quality and which are not, indicating a correct layer thickness or other measurement, and so forth. For example, in the case of OCT images, it can be desirable to extract a retinal nerve fiber layer (RNFL) thickness; thus, it can be desirable for a qualified individual to annotate images to indicate the correct thickness, which parts of the images correspond to retinal nerve fiber layers, and so forth.

At block 103, the system may create, from the received dataset, training, tuning, and testing/validation datasets, although in some embodiments not all of the datasets may be created. For example, in some cases, only a training dataset may be created, or only training and testing/validation datasets may be created. The training dataset 104 can be used during training to determine variables for forming a predictive model. The tuning dataset 105 may be used to select final models and to prevent or correct overfitting that may occur during training with the training dataset 104, as the trained model should be generally applicable to a broad spectrum of patients, while it is possible that the training dataset is biased towards those with specific conditions. For example, there may be significantly more data available for patients who have glaucoma, ocular hypertension, or other conditions than there is for patients who do not have such vision problems. The testing dataset 106 may be used after training and tuning to evaluate the model. For example, the testing dataset 106 may be used to check if the model is overfitted to the training dataset. The system, in training loop 114, may train the model at 107 using the training dataset 104. Training may be conducted in a supervised, unsupervised, or partially supervised manner. At block 108, the system may evaluate the model according to one or more evaluation criteria. For example, the evaluation can include determining whether image quality is being evaluated correctly (e.g., good OCT images are identified as such and low quality OCT images are identified as such, with relatively few misidentifications), that extracted data is correct, and/or any other desired criteria. At block 109, the system may determine if the model meets the one or more evaluation criteria. If the model fails evaluation, the system may, at block 110, tune the model using the tuning dataset 105, repeating the training 107 and evaluation 108 until the model passes the evaluation at block 109. Once the model passes the evaluation at 109, the system can exit the model training loop 114. The testing dataset 106 can be run through the trained model 111 and, at block 112, the system can evaluate the results. If the evaluation fails, at block 113, the system may reenter training loop 114 for additional training and tuning. If the model passes, the system can stop the training process, resulting in a trained model 111. In some embodiments, the training process can be modified. For example, the system may not use a testing dataset 106 in some embodiments. In some embodiments, the system can use a single dataset. In some embodiments, the system can use two datasets. In some embodiments, the system can use more than three datasets. In some embodiments, the system may not use a tuning dataset for training the model. For example, the model may have a training dataset and a testing dataset.

### Retinal Nerve Fiber Layer Measurement

One way of determining whether a patient has progressive glaucoma is to image the retinal nerve fiber layer (RFNL), which can thin over time and can show abnormally rapid thinning in patients suffering from glaucoma. Providers may image the RNFL using optical coherence tomography (OCT), for example time domain OCT, spectral domain OCT, or both. In some cases, providers may use other imaging methods for measuring the RNFL, such as scanning laser polarimetry. The techniques described herein may be used with RNFL data obtained by any means. By tracking the thickness of the RNFL over time, a provider can diagnose a patient with progressive or non-progressive glaucoma. Alone or in combination with other data, as will be discussed in more detail below, RNFL data may be used to differentiate between vision loss due to glaucoma and vision loss resulting from, for example, a stroke or tumor. Moreover, if the RNFL data is of sufficient quality, providers may be able to use the data to enable early detection and intervention.

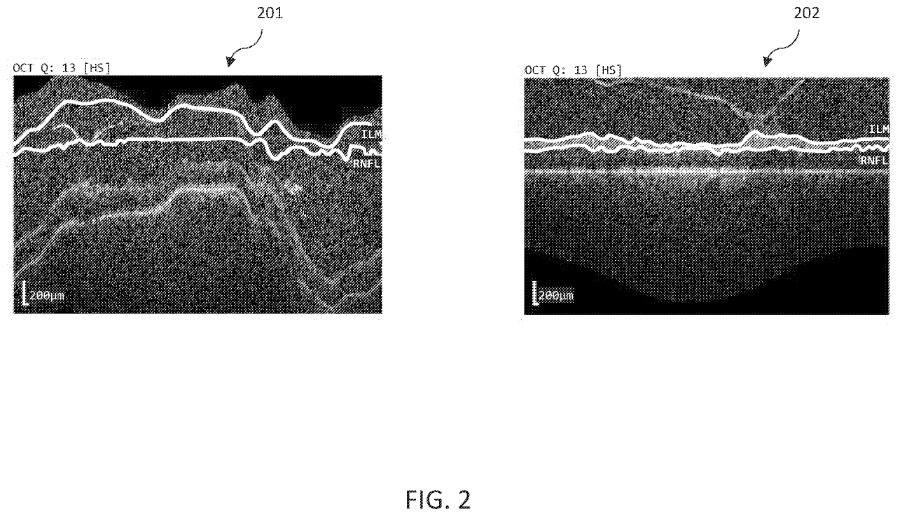

However, as mentioned briefly above, these and other measurements are prone to errors. In the case of OCT imaging, errors can have a wide variety of sources, such as, for example, poor scan centration about the optical nerve head, image noise, lack of contrast, biological artifacts, poor segmentation of the RNFL when using automated tools, biological variation, and constraints on provider time. In some embodiments, an image quality score or similar metric may be determined for an OCT image. For example, an image might be assigned an image quality score based at least in part on the signal-to-noise ratio and/or the uniformity of the signal. While an image quality score or similar metric can help to distinguish good images from poor images, simple scoring calculations can sometimes fail to identify images with significant problems. As just one example, FIG. 2 shows two OCT images that were assigned similar quality scores using conventional methods. While an image quality score or similar metric can help to distinguish good images from poor images, simple scoring calculations can sometimes fail to identify images with significant problems. As just one illustrative example, FIG. 2 shows two OCT images that were assigned similar quality scores using conventional methods. The segmentation of the RNFL and the internal limiting membrane (ILM) in the right image 202 is reasonably accurate across the image, while the segmentation of RNFL and ILM in left image 201 does not accurately reflect the patient's biology due to the poor quality of the image.

In some embodiments, computer vision systems and/or machine learning models may be used to identify OCT imaging issues that can lead to unreliable RNFL thickness measurements. For example, in some embodiments, an image classification engine can comprise a machine learning model that can be trained to identify OCT imaging issues that may lead to incorrect RNFL thickness measurements, for example as described above. In some embodiments, the image classification engine may be better able to differentiate between acceptable and unacceptable images than simple statistical analysis of OCT images. The image classification engine can be trained using, for example, annotated OCT images, wherein the annotations are indicative of the quality of the image, for example whether an image is high quality (e.g., is relatively stable across the image, has sufficient signal to noise, and so forth) or low quality (e.g., shows wide variations across the image, has a poor signal to noise ratio, and so forth).

In some embodiments, machine learning may be performed more than one time and/or using one or more sets of images. For example, in some embodiments, the system may be provided with new OCT images, and model training may be performed on a regular schedule such as nightly, weekly, monthly, or some other frequency. Alternatively or additionally, the model may be trained on an ad hoc basis such as, for example, if a new type of problem is identified with OCT images or if different OCT imaging hardware and/or software is used to collect images.

In some embodiments, a feature extraction engine can be trained to extract one or more parameters of interest from OCT images. For example, the model may be trained to identify and extract the RNFL thickness. While described as separate models, it will be appreciated by those of skill in the art that in some embodiments, the image classification engine and the feature extraction engine can be the same model.

As discussed in more detail below, other types of data can be used for monitoring or evaluating patients, either as an alternative to OCT images or in addition to OCT images. The image classification engine and/or the feature extraction engine can be suitably adapted for the analysis and extraction of features from other types of data as discussed below.

In some embodiments, a processing system, which may be the same as the system used to train the machine learning model or may be different from the system used to train the machine learning models, may be used to evaluate OCT images and/or other diagnostic data. For example, a processing system may access an OCT image and apply the trained machine learning models to determine whether the image has one or more problems and/or to extract one or more parameters of interest from the image. In some embodiments, the processing system may receive a request to evaluate an image using an application programming interface (API), may be configured to monitor a directory for new images, may be configured to load images that are added to a database, or may be configured with some other suitable means of accessing an image and/or receiving a request to evaluate an image.

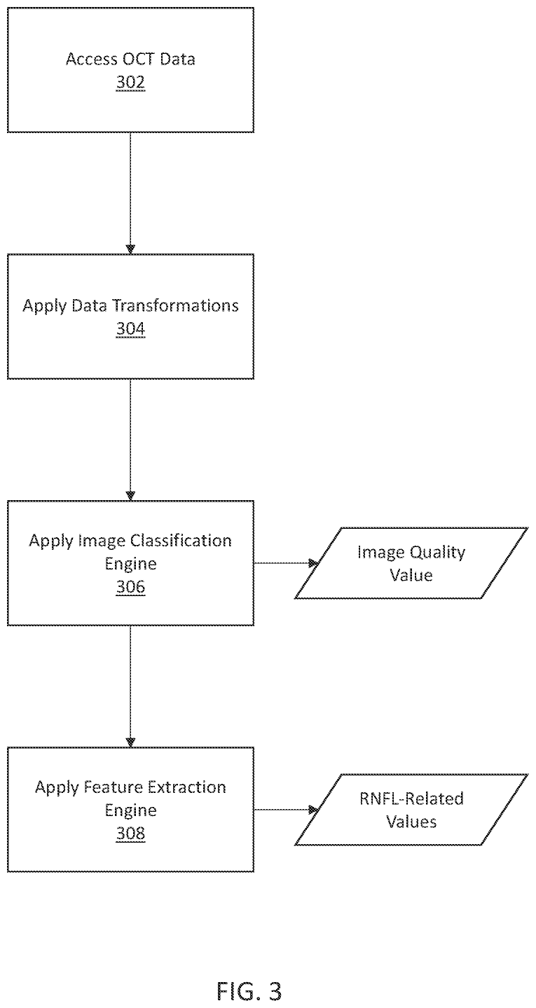

FIG. 3 illustrates an example process for analyzing an OCT image according to some embodiments. In some embodiments, the process depicted in FIG. 3 can include more steps, fewer steps, and/or the steps can be performed in a different order. As shown in FIG. 3, at block 302, a system can access OCT data. At block 304, the system can apply one or more transformations to the OCT data to prepare it for running through the trained ML models. At block 306, the system can apply the image classification engine to the accessed OCT data (e.g., an OCT image) and can output an image quality value indicating the quality of the OCT image. At block 308, the system can apply the feature extraction engine to the OCT data to extract one or more values. For example, the system may extract RNFL thickness, standard deviation, and so forth. In some embodiments, the system can extract other information from the image such as the thicknesses of other layers. The data can be used to assess macular degeneration, macular edema, and a variety of other conditions. Trend Identification, Outlier Detection and Additional Monitoring Methods

As discussed above, providers may use a variety of methods, diagnostic tests, and so forth to detect, diagnose, and monitor the presence and progression of glaucoma and other conditions that affect vision. Besides OCT imaging as discussed above, providers may additionally or alternatively measure other types of ophthalmic or optometric data such as intraocular pressure (TOP) using, for example, a tonometer and/or may conduct visual field tests on patients. Some methods, such as OCT and IOP, measure properties of the eye itself, while others such as visual field testing measure the effect of a condition, such as reduced peripheral vision. As discussed above with respect to OCT imaging, and as described below with respect to other types of monitoring such as IOP measurement and visual field testing, determining changes in testing data that may warrant medical intervention can be difficult as such data tend to be sparse and highly variable. Individual test results can be unreliable due to a wide range of possible issues as described herein.

Regardless of the particular tests or measurements that are performed, it may be advantageous to monitor a patient over time. For example, if a provider observes that a patient's intraocular pressure is consistently higher than the normal range (e.g., greater than about 22 mm Hg), that a patient's RNFL thickness is decreasing at an abnormally high rate, or that a patient's peripheral vision is declining at an abnormally high rate, the provider may pursue a course of treatment such as prescribing eye drops to reduce pressure, may perform a procedure such as trabeculoplasty or iridotomy, and/or may take other measures to treat the patient.

Because nervous tissue damage is generally irreversible, early detection and intervention is important to preserve patient vision and avoid preventable permanent vision loss. However, providers may often fail to notice concerning patterns in patient data. This can arise for a variety of reasons. For example, measurement data may be collected at irregular intervals, may be noisy, and/or may have large outliers, making it difficult to recognize underlying trends. Providers may have limited time to review a patient's history and thus may only review a limited set of data. For example, at times a provider may only review the data collected at the previous visit or the previous few visits, which can be insufficient for identifying issues, particularly if the data are noisy or otherwise unreliable. Thus, in some embodiments, improved methods for detecting outliers in data and for identifying trends can be beneficial.

In some embodiments, RNFL thickness may be measured over time using, for example, OCT imaging as described above. In some embodiments, a rate of thinning may be determined. In some embodiments, changes in the rate of thinning may be determined. In some embodiments, a change in the rate of thinning may coincide with clinical intervention (e.g., a surgical procedure or starting treatment with prescription eye drops). In some embodiments, it may be possible to project a future thickness of the RNFL based at least in part on prior RNFL thickness measurements.

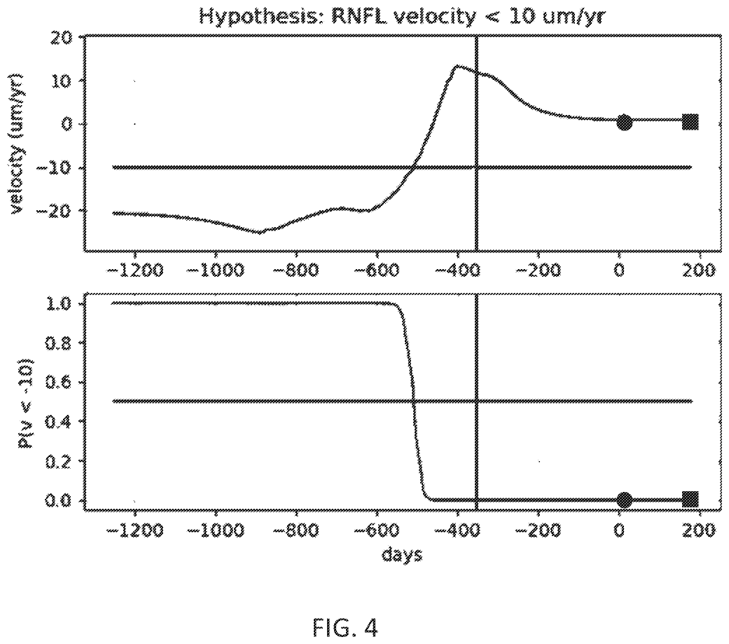

FIG. 4 illustrates an example of tracking RNFL thickness velocity over time. As shown in FIG. 4, it can be desirable to evaluate whether the rate of thinning of the RNFL (e.g., RNFL velocity) is below a threshold value of about −5 μm/year, about −10 μm/year, about −15 μm/year, any number between these numbers, or more or less, as may be set by the provider and may depend on a variety of factors such as age. For example, a younger patient may typically have a lower RNFL velocity than an older patient, and the threshold RNFL velocity may accordingly be set lower than for an older patient.

As shown in FIG. 4, RNFL thickness measurements can be collected over time and a RNFL velocity can be determined. FIG. 4 depicts a scenario in which, in the past, the patient's RNFL velocity was negative (i.e., thinning) at more than the threshold rate of −10 μm/year. As shown in the bottom plot, the probability that the patient's RNFL was thinning at more than the threshold rate varies over time. For example, when the velocity was far below −10 μm/year, the probability of thinning at greater than the threshold rate was around 1. However, the velocity subsequently increased and, accordingly, the probability decreased. The vertical line can indicate a date of an intervention such as a surgical procedure, beginning prescription treatment, and/or the like. The black circle can indicate a current velocity and current probability. The black square can indicate a prediction of a future velocity and probability. Methods for calculating robust thickness, velocity, probabilities, and the like are discussed in more detail below.

As discussed above, in some embodiments, OCT imaging data may have one or more problems that result in inaccurate RNFL thickness values. In some embodiments, a machine learning model may be used to identify images that should not be used to determine RNFL thickness, for example using an image classification engine as described above. However, some problematic images may not be identified, leading to inaccurate RNFL thickness measurements. Moreover, in some embodiments, a machine learning model may not be used to identify problematic images and exclude them from consideration in determining RNFL thickness. Rather, some providers may rely on more conventional methods of analyzing OCT data. If simple image statistics are used instead of the image classification engine, the chances of a problematic image being used to determine RNFL thickness may be significantly higher than if the image classification engine is used, and in either case there can be a significant chance that data from poor quality OCT images is included. Thus, it can be important to properly account for inaccurate, outlier data when analyzing trends in patient data. Such issues can be especially important for other types of data where it can be harder to identify problem measurements in isolation.

In some embodiments, TOP measurements may be used instead of or in addition to OCT images to monitor a patient's eye health. In some cases, TOP measurements can be gathered quickly and easily using a desktop or handheld tonometer. Thus, providers may collect TOP data relatively frequently compared to some other types of data. TOP measurements may be noisy. For example, there may be significant variation in TOP measurements taken close together in time. For example, measurements taken only days apart, or even on the same day, may yield results that indicate normal TOP (e.g., about 12-22 mm Hg) and high TOP (e.g., greater than about 22 mm Hg). Variability may arise for a number of reasons. For example, inaccurately high measurements may result if a patient is wearing a tie or a tight collar, or if the patient advertently or inadvertently holds their breath during the procedure, which may cause an increase in venous pressure, or a patient or provider may inadvertently apply pressure to the eye during the procedure. Unlike OCT data, there may not be a readily apparent means of evaluating the quality of a single TOP measurement. Thus, it can be important to consider multiple TOP measurements in order to make determinations about data quality. For example, if multiple TOP measurements are taken at or around the same time, any data points that are far from the mean could be outliers and may, in some cases, be discarded or given lesser weight. Similarly, if a data point collected at one patient visit is significantly higher or significantly lower than data collected at previous and/or subsequent patient visits, that data point may be excluded as likely being inaccurate.

In some embodiments, alternatively or in addition to OCT and/or TOP data, a provider may use visual field data to detect and diagnose progressive glaucoma or other conditions that may affect vision. Visual field test data may be prone to significant errors and noise. During a typical visual field test, a patient may be asked to look directly forward and identify flashes of light of varying intensities that appear in their peripheral vision. Visual field tests may take an extended period of time, such as ten or fifteen minutes. In some circumstances, a patient may struggle to complete the test, prolonging the time required to complete the test. In some embodiments, visual field data may be unreliable and/or inconsistent if, for example, a patient fails to respond to an event that the patient observed, the patient glances away from a central focus point, the patient becomes fatigued, or the patient has dry or sticky eyes. A patient may demonstrate significantly different performance on visual field tests administered at different times. Even within a single administration, a patient may perform better at the beginning and decline as the test progresses due to fatigue. Alternatively or additionally, a patient may perform poorly at the beginning of a visual field test because the patient is unfamiliar with the procedure and fails to accurately register responses. In some embodiments, a machine learning model can be trained, for example as described above, to detect patterns in visual field data that indicate user fatigue, lack of familiarity, and so forth, although in some cases the visual field data may not be conducive to such analysis, for example if there is no time-series information available.

Visual field test data may comprise, for example, pattern deviation data and/or total deviation data. In some embodiments, visual field data may be divided into one or more regions and a mean total deviation, mean pattern deviation, and/or the like may be determined for each region and/or for all regions combined.

In addition to potential problems that arise from the testing process, it may be especially difficult to identify trends in visual field data because visual field tests are time-consuming and thus tend to be done infrequently. Moreover, commercially available test equipment may provide visual field test results in the form of images or other formats that are not conducive to data analysis, making it difficult for providers to compare data over time.

Thus, in some embodiments, optical character recognition or other computer vision methods may be used to extract data from visual field test results.

As described above in relation to OCT imaging, IOP measurements and visual field testing data are all prone to significant errors and other issues (for example, data sparseness) that may make it difficult to identify inaccurate data and/or to identify trends in the data. Thus, it may be beneficial to have systems and methods for performing analysis of patient data to identify outlier measurements and to identify trends in the data.

In some embodiments, regression analysis may be used to determine one or more properties of patient data such as, for example, a change in RNFL thickness over time, a change in the rate of RNFL thinning over time, a change in IOP over time, or a change in visual field test performance over time (e.g., worsening peripheral vision). In some embodiments, regression analysis may be used to, for example, predict one or more future values such as a future RNFL thickness or a future IOP.

In some embodiments, patient data such as, for example, RNFL thickness, IOP, or visual field test data, may be taken at irregular intervals. In some embodiments, multiple measurements may be taken on the same day or very close together in time (for example, within a few weeks), while at other times, measurements may be spaced weeks, months, or even years apart. In some embodiments, patient data may be heteroscedastic. For example, measurements of RNFL thickness, IOP, visual field, or other measurements may be relatively consistent during one period of time but have large variance during a second period of time. This could occur, for example, because of a change in the patient's condition or because, for example, a different, less-experienced provider performed testing during the second period of time or because equipment needed to be calibrated or parts needed to be replaced during the second period of time.

Regression analysis can be used to determine trends in data. However, traditional regression methods may be unsuitable for OCT, TOP, and visual field data for multiple reasons such as, for example, differences in data density, repeated measurements on the same day, extreme outliers, and heteroscedasticity. Simple linear regressions, for example, may be strongly influenced by issues that appear in OCT, TOP, and visual field data. For example, extreme outliers may pull the regression far away from the true trend, and data points that are far away from other data (for example, if there are several measurements collected within a period of a few weeks or months, and one measurement collected a year earlier) may have an undue influence on the calculated slope. Locally Estimated Scatterplot Smoothing (LOESS) is a well-known technique that may resolve some of the problems of simple linear regressions but may still fail when applied to patient data. For example, LOESS may be suitable when there are differences in data density or when there are extreme outliers in non-heteroscedastic data. However, LOESS may result in choppy behavior and/or indeterminacy when there are multiple data points collected on a single day, especially if the multiple points appear on the border of a window. For example, if two measurements are taken on the same day, the order of the measurements in the data may be important. As just one example, if a window is set to the nearest ten measurements, and the tenth and eleventh closest measurements both occur on the same day, the result of the regression may vary considerably depending on which measurement (the tenth or the eleventh) is considered to be within the window, especially in the case where one of the measurements may be an outlier. LOESS also struggles with extreme outliers when the data are heteroscedastic, as explained in more detail below.

In some embodiments, outliers may be rejected using a condition, rule, weighting, or the like such as, for example, a robustness weighting. In some embodiments, an iterative kernel-based regression may be used to estimate one or more parameters. For example, a kernel-based method such as LOESS may comprise an inner loop that estimates a function that fits the data and an outer loop that rejects outliers using robustness weights. Kernel-based methods, such as LOESS, may determine outliers based at least in part on global variance (e.g., the variance of all or substantially all of the data in the data set). This can be especially problematic for heteroscedastic data. For example, an envelope (e.g., a range of values) in which valid, non-outlier data is expected to fall may be determined based on all or substantially all of a data set. If the data are heteroscedastic, the envelope may be too wide at periods in the data where the data are relatively stable but may be too narrow when the data are relatively noisy. In some embodiments, using the global variance of a data set may cause valid points to be excluded, may cause some outliers to be included, or both.

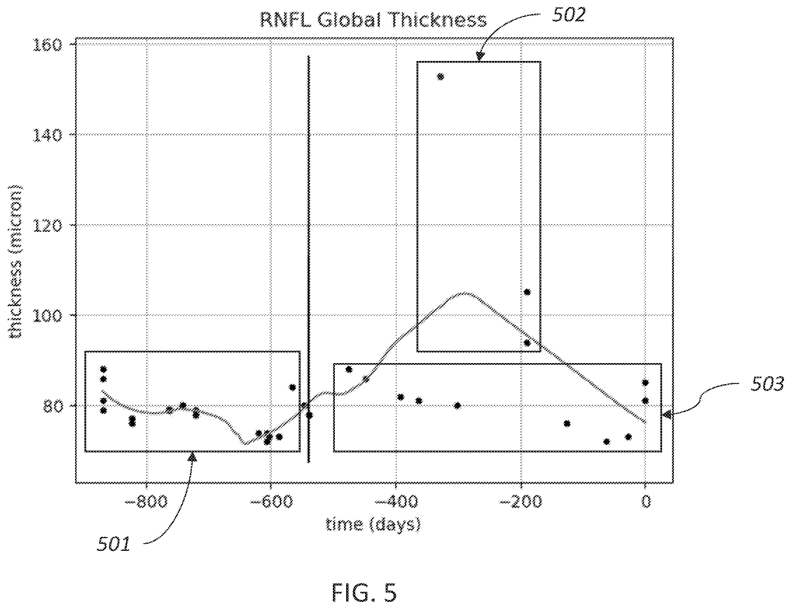

For example, FIG. 5 is an example of a regression that is inaccurate due to outliers. In FIG. 5, an initial solution (indicated by the solid path) to the regression is pulled away from valid data by the presence of outliers. In a subsequent iteration, the regression algorithm may exclude anything that appears to be an outlier (i.e., anything outside the envelope). In the example of FIG. 5, the relatively tight distribution of data earlier in time, marked by box 501, causes the overall variance to be low (and, accordingly, the envelope to be relatively small). The outliers in box 502 may pull the initial solution upward and away from the valid data in box 503. As a result, valid data in box 503 may be excluded because the initial fit has been pulled up by the outliers in box 502, while the envelope size is limited as a result of the tight distribution of data in box 501, resulting in a final regression that does not reflect the underlying valid data during periods of increased variance.

In some embodiments, local statistics may be used. For example, in some embodiments, instead of using the variance for an entire data set (or substantially all of a data set) to determine a single envelope, a regression may determine one or more envelopes based on, for example, the closest one tenth, one quarter, one half, two thirds, or some other fraction of the data. In some embodiments, instead of determining the number of points to include, a regression may instead be configured with a number of days to include, which may be especially advantageous for patient data which can often be sporadic (e.g., at one time period, including five closest data points could encompass several years of data, while at another time period, the same number of data points could include only days or weeks).

In some embodiments, a compact kernel function may be used at least in part in order to reduce the computational complexity of the regression. However, in some embodiments, a non-compact kernel may be used instead of a compact kernel. In some embodiments, a non-compact kernel (such as a Gaussian kernel) may be advantageous because it tapers off to zero gradually rather than having a hard stop. This may improve the robustness of calculations. For example, a compact kernel may give weight to a measurement taken 29 days ago but may completely disregard a measurement taken 31 days ago, even though both measurements may be of nearly the same clinical relevance. A non-compact kernel, in contrast, may give some weight to the measurement taken 29 days ago and a lesser (but non-zero) weight to the measurement taken 31 days ago.

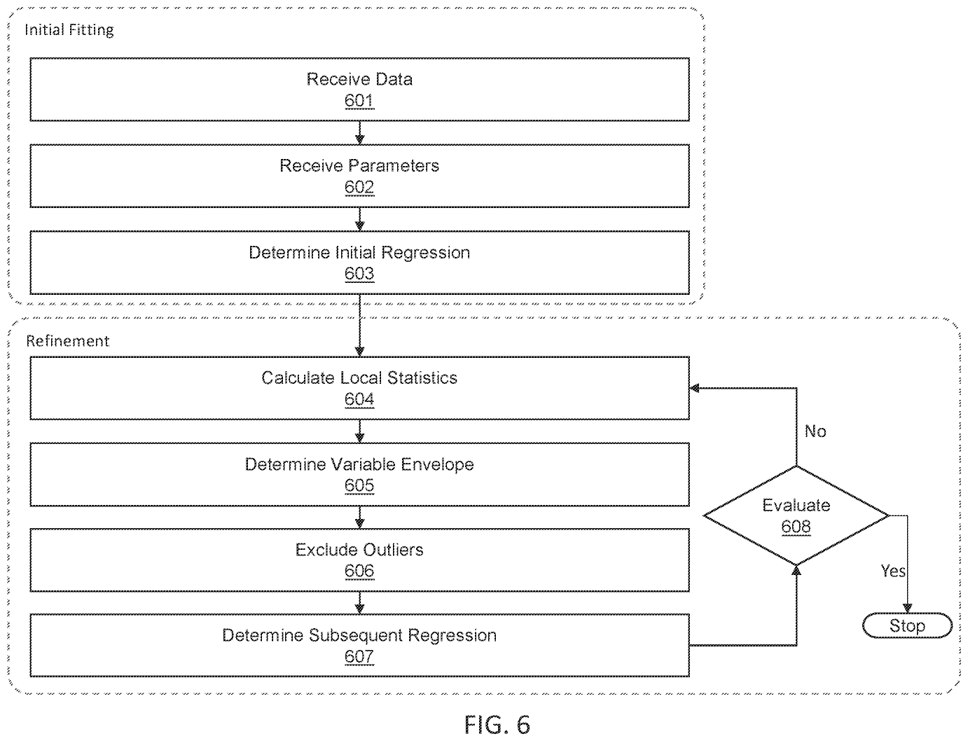

FIG. 6 is a block diagram that illustrates a process for performing a regression using local statistics according to an embodiment. The process may be run on a computing system. At block 601, the system may receive data, for example, RNFL thickness data, IOP data, visual field data, and/or the like. At block 602, the system may receive one or more regression fitting parameters for performing a regression. For example, the system may receive an indication of the number of days that should be included within a window for performing the regression, a number of visits to include, or a number of data points to include. The regression fitting parameters can include a type of kernel to use (e.g., compact, non-compact, Gaussian, Lorentzian, etc.). At block 603, the system may determine an initial regression based on all or substantially all of the received data. At block 604, the system may calculate one or more local statistics. For example, the system may determine the variance for each window. At block 605, the system may determine an envelope that may vary across the data, based at least in part on the calculated local statistics. At block 606, the system may exclude one or more outliers that are outside the variable envelope. At block 607, the system may determine a second regression based on the received data and excluding the outliers. In some embodiments, blocks 604, 605, 606, and 607 may be repeated a specified number or times or may repeat until a condition, such as a minimum change in the regression from iteration to iteration (i.e., until the solution converges), is achieved, for example as may be evaluated at block 608, wherein the process can continue the evaluation criteria are not met or can stop if the criteria are met.

In some embodiments, outliers in RNFL, TOP, visual field, or other data may be identified using a regression algorithm that uses local statistics to determine one or more envelopes and/or that bases the window size at least in part on a number of days or number of visits to include rather than, for example, a number of data points to include. In some embodiments, regressions that use local statistics and/or time-based envelopes may better determine outliers and thus may provide a better indication of trends in the data. Basing the window size on a number of days or number of visits to include prevents the indeterminacy and ordering problems discussed above when multiple measurements are collected on the same day or at the same visit. For example, a window that is based on a nearest ten visits will include all the measurements collected at each of the nearest ten visits, regardless of how many measurements were taken at each visit. For example, if one measurement was collected at each of nine visits and two measurements were collected at one visit, all eleven measurements would be included in the window.

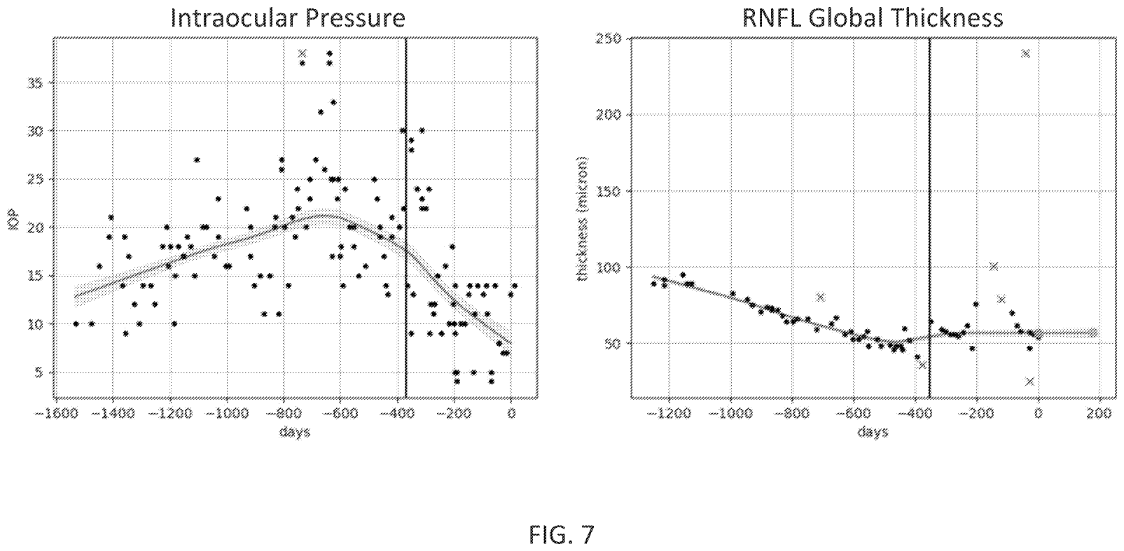

In some embodiments, a regression may not account for one or more intervention dates (for example, when a patient is prescribed eye drops or a surgical procedure is performed). In some embodiments, a regression that does not account for one or more intervention dates may cause it to appear that, for example, a rate of thinning changes prior to clinical intervention. For example, FIG. 7 shows example regressions for intraocular pressure and RNFL thickness that do not account for intervention dates. As shown in FIG. 7, it appears that the patient's TOP started decreasing before the intervention date, and the patient's RNFL thickness stabilized prior to the intervention date. In some embodiments, a regression may account for one or more clinical interventions. In some embodiments, a regression may be discontinuous when one or more interventions occur. For example, in some embodiments, a regression may treat pre-intervention and post-intervention data separately. In some embodiments, values at the time of intervention can operate as boundary conditions. For example, if a regression treats pre- and post-intervention data separately, a system can be configured to require that the pre-intervention regression matches with the post-intervention regression at the time of the intervention (e.g., the two regressions are within a defined limit of each other at the time of intervention).

In some embodiments, outliers may be detected while a patient is at the provider. This may enable a provider to discard an outlier and collect a new measurement while the patient is still at the appointment. In some embodiments, a statistical quantity, such as, for example, a p value, may be used to determine how likely it is that a measurement is an outlier. In some embodiments, a credibility interval may be determined based at least in part on one or more prior measurements.

In some embodiments, a prediction of a future thickness may be determined such as, for example, a predicted thickness 30 days, 60 days, 90 days, 180 days, or some other amount of time from the most recent measurement. In some embodiments, an RNFL velocity estimation may be determined. In some embodiments, a credibility interval for the RNFL velocity may be determined based at least in part on one or more prior measurements. In some embodiments, a probability that the RNFL velocity is above or below a threshold value may be determined. In some embodiments, a threshold may be, for example, 5 μm per year, 10 μm per year, 15 μm per year, or some other clinically relevant threshold. In some embodiments, a predicted future RNFL thickness may be determined such as, for example, a predicted thickness 30 days, 60 days, 90 days, 180 days, or some other time from the most recent measurement. It will be understood that other measurements, estimates, projections, and the like are possible, such as, for example, a projection of the rate of change of the RNFL thickness velocity.

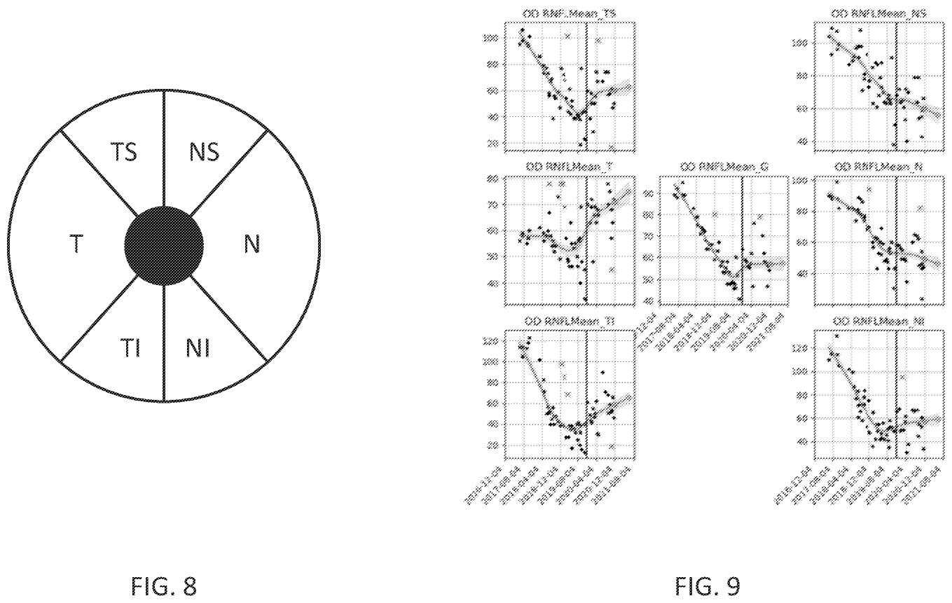

It will be appreciated by those of skill in the art that changes in a patient's RNFL thickness, IOP, and/or peripheral vision may not be uniform. For example, increased RNFL thinning may be observed in one region of the retinal nerve fiber layer relative to another. Accordingly, the systems and methods herein are not limited to global or average measurements but instead can include regional measurements. For example, visual field data, RNFL measurements, and/or IOP measurements may be divided into regions such as, for example, the inferonasal (NI), inferotemporal (TI), nasal (N), superonasal (NS), superotemporal (TS), and/or temporal (T) regions, as indicated in FIG. 8. FIG. 9 illustrates an example of RNFL trend data in various regions.

### Multimodal Patient Monitoring and Analysis

The testing methods discussed above as well as other types of medical tests may provide insight into a patient's vision health. The results of visual testing may also indicate other health problems, and/or other patient health information may indicate an increased likelihood of developing particular conditions that can affect vision. In some embodiments, various test data may be analyzed in combination to help identify one or more conditions that a patient is suffering from. In some embodiments, patterns in visual field data (for example, poor test performance in one or more regions) may correspond to features in the RNFL data. For example, an inferior defect at the bottom of the eye, such as relatively low RNFL thickness, may correspond to a superior defect in the visual field. In some embodiments, a patient who has decreased peripheral vision in one or more regions and corresponding thinning of the RNFL may be diagnosed with glaucoma. In some embodiments, the relationships between different types of diagnostic data may be complex such that it would be impracticable for a provider to identify the relationships and to determine which condition or conditions might result in the observed diagnostic data without the use of an ML model.

In some embodiments, observations in visual field data may not have corresponding observations in RNFL data. For example, a patient may show decreased peripheral vision in one or more regions while OCT imaging may not show concerning RNFL thinning. In some embodiments, poor performance in one or more regions in visual field test data without corresponding RNFL thinning may indicate another medical condition, such as that the patient has suffered from a stroke, that the patient has a brain tumor in the visual cortex, or that the patient's eyelid was sagging and blocking their vision.

Providers may not always recognize patterns in multiple types of vision testing data, especially, for example, in the case of more complex patterns or when different data is collected at different times (e.g., IOP may be collected at one appointment while visual field data or OCT data are collected at another appointment). Thus, it may be advantageous to use ML models to identify patterns across data sources. For example, in some embodiments, a machine learning model may be trained using patient test data and known patient conditions to identify patterns in patient test data that correspond to particular conditions. For example, in some embodiments, the machine learning model may be trained to identify glaucoma by ingesting IOP, RNFL, and visual field data for patients known to have glaucoma. In some embodiments, the machine learning model can ingest electronic medical record data. In some embodiments, a data set can include both patients that have and that do not have glaucoma, and the data can be annotated to indicate which patients have glaucoma which do not. In some embodiments, a data set can include patients who have other conditions in addition to glaucoma or instead of glaucoma. Thus, in some embodiments, a model can be trained to identify multiple types of medical conditions that can lead to vision problems. In some embodiments, the machine learning model may be trained to differentiate between different conditions by, for example, training the machine learning model using IOP, RNFL, and visual field data for a first plurality of patients known to have a second plurality of conditions. In some embodiments, the second plurality may be greater than the first plurality because, for example, a single patient may have more than one condition that affects the outcome of one or more tests.

In some embodiments, the machine learning model may comprise, for example, a neural network (e.g., a recurrent neural network, convolutional neural network, feed-forward neural network, or other type of neural network), random forest, naïve Bayes classifier, and/or other suitable algorithm. In some embodiments, a machine learning model can comprise multiple networks, classifiers, etc. In some embodiments, the machine learning model may access data from an electronic medical record system. In some embodiments, the machine learning model may be trained using patient demographic information such as, for example, age, gender, family history, ethnicity, and so forth, as well as health data indicating comorbidities, prescription medications, over-the-counter medications, lifestyle factors (for example, whether the patient smokes or drinks excessively), and so forth. In some embodiments, one or more factors may be relevant to determining how likely a patient is to develop one or more conditions. For example, in some embodiments, a patient's ethnicity or gender may indicate a higher risk of a particular condition such as glaucoma and/or may indicate a higher risk that a condition will progress.

In some embodiments, risk factors for conditions are known. For example, a patient with diabetes is known to be at a higher risk for neovascular glaucoma. Hispanics and African Americans are more likely to have open-angle glaucoma, while acute angle-closure glaucoma is more common in those of Asian descent. In some embodiments, risk factors may not be known. In some embodiments, the machine learning model may identify additional risk factors. For example, the machine learning model may identify risks associated with being part of an understudied ethnic group or may identify medical conditions or medications that lead to a higher risk of developing one or more conditions that affect vision, which may otherwise go unrecognized due to the large numbers of possible conditions, behaviors, medications, demographic data, and combinations thereof. Computer Systems

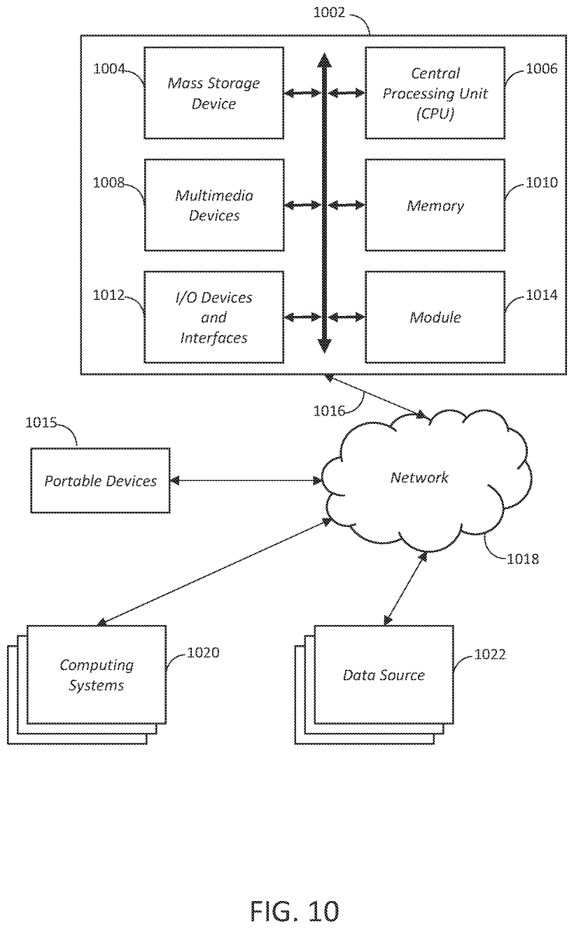

FIG. 10 is a block diagram depicting an embodiment of a computer hardware system configured to run software for implementing one or more embodiments disclosed herein.

In some embodiments, the systems, processes, and methods described herein are implemented using a computing system, such as the one illustrated in FIG. 10. The example computer system 1002 is in communication with one or more computing systems 1020 and/or one or more data sources 1022 via one or more networks 1018. While FIG. 10 illustrates an embodiment of a computing system 1002, it is recognized that the functionality provided for in the components and modules of computer system 1002 may be combined into fewer components and modules, or further separated into additional components and modules.

The computer system 1002 can comprise a module 1014 that carries out the functions, methods, acts, and/or processes described herein. The module 1014 is executed on the computer system 1002 by a central processing unit 1006 discussed further below.

In general, the word “module,” as used herein, refers to logic embodied in hardware or firmware or to a collection of software instructions, having entry and exit points. Modules are written in a program language, such as JAVA, C or C++, Python, or the like. Software modules may be compiled or linked into an executable program, installed in a dynamic link library, or may be written in an interpreted language such as BASIC, PERL, LUA, or Python. Software modules may be called from other modules or from themselves, and/or may be invoked in response to detected events or interruptions. Modules implemented in hardware include connected logic units such as gates and flip-flops, and/or may include programmable units, such as programmable gate arrays or processors.

Generally, the modules described herein refer to logical modules that may be combined with other modules or divided into sub-modules despite their physical organization or storage. The modules are executed by one or more computing systems and may be stored on or within any suitable computer readable medium or implemented in-whole or in-part within special designed hardware or firmware. Not all calculations, analysis, and/or optimization require the use of computer systems, though any of the above-described methods, calculations, processes, or analyses may be facilitated through the use of computers. Further, in some embodiments, process blocks described herein may be altered, rearranged, combined, and/or omitted.

The computer system 1002 includes one or more processing units (CPU) 1006, which may comprise a microprocessor. The computer system 1002 further includes a physical memory 1010, such as random-access memory (RAM) for temporary storage of information, a read only memory (ROM) for permanent storage of information, and a mass storage device 1004, such as a backing store, hard drive, rotating magnetic disks, solid state disks (SSD), flash memory, phase-change memory (PCM), 3D XPoint memory, diskette, or optical media storage device. Alternatively, the mass storage device may be implemented in an array of servers. Typically, the components of the computer system 1002 are connected to the computer using a standards-based bus system. The bus system can be implemented using various protocols, such as Peripheral Component Interconnect (PCI), Micro Channel, SCSI, Industrial Standard Architecture (ISA) and Extended ISA (EISA) architectures.

The computer system 1002 includes one or more input/output (I/O) devices and interfaces 1012, such as a keyboard, mouse, touch pad, and printer. The I/O devices and interfaces 1012 can include one or more display devices, such as a monitor, that allows the visual presentation of data to a user. More particularly, a display device provides for the presentation of GUIs as application software data, and multi-media presentations, for example. The I/O devices and interfaces 1012 can also provide a communications interface to various external devices. The computer system 1002 may comprise one or more multi-media devices 1008, such as speakers, video cards, graphics accelerators, and microphones, for example.

The computer system 1002 may run on a variety of computing devices, such as a server, a Windows server, a Structure Query Language server, a Unix Server, a personal computer, a laptop computer, and so forth. In other embodiments, the computer system 1002 may run on a cluster computer system, a mainframe computer system and/or other computing system suitable for controlling and/or communicating with large databases, performing high volume transaction processing, and generating reports from large databases. The computing system 1002 is generally controlled and coordinated by an operating system software, such as Windows XP, Windows Vista, Windows 7, Windows 8, Windows 10, Windows 11, Windows Server, Unix, Linux (and its variants such as Debian, Linux Mint, Fedora, and Red Hat), SunOS, Solaris, Blackberry OS, z/OS, iOS, macOS, or other operating systems, including proprietary operating systems. Operating systems control and schedule computer processes for execution, perform memory management, provide file system, networking, and I/O services, and provide a user interface, such as a graphical user interface (GUI), among other things.

The computer system 1002 illustrated in FIG. 10 is coupled to a network 1018, such as a LAN, WAN, or the Internet via a communication link 1016 (wired, wireless, or a combination thereof). Network 1018 communicates with various computing devices and/or other electronic devices. Network 1018 is communicating with one or more computing systems 1020 and one or more data sources 1022. The module 1014 may access or may be accessed by computing systems 1020 and/or data sources 1022 through a web-enabled user access point. Connections may be a direct physical connection, a virtual connection, and other connection type. The web-enabled user access point may comprise a browser module that uses text, graphics, audio, video, and other media to present data and to allow interaction with data via the network 1018.

Access to the module 1014 of the computer system 1002 by computing systems 1020 and/or by data sources 1022 may be through a web-enabled user access point such as the computing systems' 1020 or data source's 1022 personal computer, cellular phone, smartphone, laptop, tablet computer, e-reader device, audio player, or another device capable of connecting to the network 1018. Such a device may have a browser module that is implemented as a module that uses text, graphics, audio, video, and other media to present data and to allow interaction with data via the network 1018.

The output module may be implemented as a combination of an all-points addressable display such as a cathode ray tube (CRT), a liquid crystal display (LCD), a plasma display, or other types and/or combinations of displays. The output module may be implemented to communicate with input devices 1012 and they also include software with the appropriate interfaces which allow a user to access data through the use of stylized screen elements, such as menus, windows, dialogue boxes, tool bars, and controls (for example, radio buttons, check boxes, sliding scales, and so forth). Furthermore, the output module may communicate with a set of input and output devices to receive signals from the user.

The input device(s) may comprise a keyboard, roller ball, pen and stylus, mouse, trackball, voice recognition system, or pre-designated switches or buttons. The output device(s) may comprise a speaker, a display screen, a printer, or a voice synthesizer. In addition, a touch screen may act as a hybrid input/output device. In another embodiment, a user may interact with the system more directly such as through a system terminal connected to the score generator without communications over the Internet, a WAN, or LAN, or similar network.

In some embodiments, the system 1002 may comprise a physical or logical connection established between a remote microprocessor and a mainframe host computer for the express purpose of uploading, downloading, or viewing interactive data and databases on-line in real time. The remote microprocessor may be operated by an entity operating the computer system 1002, including the client server systems or the main server system, an/or may be operated by one or more of the data sources 1022 and/or one or more of the computing systems 1020. In some embodiments, terminal emulation software may be used on the microprocessor for participating in the micro-mainframe link.

In some embodiments, computing systems 1020 who are internal to an entity operating the computer system 1002 may access the module 1014 internally as an application or process run by the CPU 1006.

In some embodiments, one or more features of the systems, methods, and devices described herein can utilize a URL and/or cookies, for example for storing and/or transmitting data or user information. A Uniform Resource Locator (URL) can include a web address and/or a reference to a web resource that is stored on a database and/or a server. The URL can specify the location of the resource on a computer and/or a computer network. The URL can include a mechanism to retrieve the network resource. The source of the network resource can receive a URL, identify the location of the web resource, and transmit the web resource back to the requestor. A URL can be converted to an IP address, and a Domain Name System (DNS) can look up the URL and its corresponding IP address. URLs can be references to web pages, file transfers, emails, database accesses, and other applications. The URLs can include a sequence of characters that identify a path, domain name, a file extension, a host name, a query, a fragment, scheme, a protocol identifier, a port number, a username, a password, a flag, an object, a resource name and/or the like. The systems disclosed herein can generate, receive, transmit, apply, parse, serialize, render, and/or perform an action on a URL.

A cookie, also referred to as an HTTP cookie, a web cookie, an internet cookie, and a browser cookie, can include data sent from a web site and/or stored on a user's computer. This data can be stored by a user's web browser while the user is browsing. The cookies can include useful information for websites to remember prior browsing information, such as a shopping cart on an online store, clicking of buttons, login information, and/or records of web pages or network resources visited in the past. Cookies can also include information that the user enters, such as names, addresses, passwords, credit card information, etc. Cookies can also perform computer functions. For example, authentication cookies can be used by applications (for example, a web browser) to identify whether the user is already logged in (for example, to a web site). The cookie data can be encrypted to provide security for the consumer. Tracking cookies can be used to compile historical browsing histories of individuals. Systems disclosed herein can generate and use cookies to access data of an individual. Systems can also generate and use JSON web tokens to store authenticity information, HTTP authentication as authentication protocols, IP addresses to track session or identity information, URLs, and the like.

The computing system 1002 may include one or more internal and/or external data sources (for example, data sources 1022). In some embodiments, one or more of the data repositories and the data sources described above may be implemented using a relational database, such as Sybase, Oracle, CodeBase, DB2, PostgreSQL, and Microsoft® SQL Server as well as other types of databases such as, for example, a NoSQL database (for example, Couchbase, Cassandra, or MongoDB), a flat file database, an entity-relationship database, an object-oriented database (for example, InterSystems Cache), a cloud-based database (for example, Amazon RDS, Azure SQL, Microsoft Cosmos DB, Azure Database for MySQL, Azure Database for MariaDB, Azure Cache for Redis, Azure Managed Instance for Apache Cassandra, Google Bare Metal Solution for Oracle on Google Cloud, Google Cloud SQL, Google Cloud Spanner, Google Cloud Big Table, Google Firestore, Google Firebase Realtime Database, Google Memorystore, Google MongoDB Atlas, Amazon Aurora, Amazon DynamoDB, Amazon Redshift, Amazon ElastiCache, Amazon MemoryDB for Redis, Amazon DocumentDB, Amazon Keyspaces, Amazon Neptune, Amazon Timestream, or Amazon QLDB), a non-relational database, or a record-based database.

The computer system 1002 may also access one or more databases 1022. The databases 1022 may be stored in a database or data repository. The computer system 1002 may access the one or more databases 1022 through a network 1018 or may directly access the database or data repository through I/O devices and interfaces 1012. The data repository storing the one or more databases 1022 may reside within the computer system 1002. Additional Embodiments

In the foregoing specification, the systems and processes have been described with reference to specific embodiments thereof. It will, however, be evident that various modifications and changes may be made thereto without departing from the broader spirit and scope of the embodiments disclosed herein. The specification and drawings are, accordingly, to be regarded in an illustrative rather than restrictive sense.

Indeed, although the systems and processes have been disclosed in the context of certain embodiments and examples, it will be understood by those skilled in the art that the various embodiments of the systems and processes extend beyond the specifically disclosed embodiments to other alternative embodiments and/or uses of the systems and processes and obvious modifications and equivalents thereof. In addition, while several variations of the embodiments of the systems and processes have been shown and described in detail, other modifications, which are within the scope of this disclosure, will be readily apparent to those of skill in the art based upon this disclosure. It is also contemplated that various combinations or sub-combinations of the specific features and aspects of the embodiments may be made and still fall within the scope of the disclosure. It should be understood that various features and aspects of the disclosed embodiments can be combined with, or substituted for, one another in order to form varying modes of the embodiments of the disclosed systems and processes. Any methods disclosed herein need not be performed in the order recited. Thus, it is intended that the scope of the systems and processes herein disclosed should not be limited by the particular embodiments described above.

It will be appreciated that the systems and methods of the disclosure each have several innovative aspects, no single one of which is solely responsible or required for the desirable attributes disclosed herein. The various features and processes described above may be used independently of one another or may be combined in various ways. All possible combinations and sub-combinations are intended to fall within the scope of this disclosure.

Certain features that are described in this specification in the context of separate embodiments also may be implemented in combination in a single embodiment. Conversely, various features that are described in the context of a single embodiment also may be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination. No single feature or group of features is necessary or indispensable to each and every embodiment.

It will also be appreciated that conditional language used herein, such as, among others, “can,” “could,” “might,” “may,” “for example,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open- ended fashion, and do not exclude additional elements, features, acts, operations, and so forth. In addition, the term “or” is used in its inclusive sense (and not in its exclusive sense) so that when used, for example, to connect a list of elements, the term “or” means one, some, or all of the elements in the list. In addition, the articles “a,” “an,” and “the” as used in this application and the appended claims are to be construed to mean “one or more” or “at least one” unless specified otherwise. Similarly, while operations may be depicted in the drawings in a particular order, it is to be recognized that such operations need not be performed in the particular order shown or in sequential order, or that all illustrated operations be performed, to achieve desirable results. Further, the drawings may schematically depict one or more example processes in the form of a flowchart. However, other operations that are not depicted may be incorporated in the example methods and processes that are schematically illustrated. For example, one or more additional operations may be performed before, after, simultaneously, or between any of the illustrated operations. Additionally, the operations may be rearranged or reordered in other embodiments. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products. Additionally, other embodiments are within the scope of the following claims. In some cases, the actions recited in the claims may be performed in a different order and still achieve desirable results.

Further, while the methods and devices described herein may be susceptible to various modifications and alternative forms, specific examples thereof have been shown in the drawings and are herein described in detail. It should be understood, however, that the embodiments are not to be limited to the particular forms or methods disclosed, but, to the contrary, the embodiments are to cover all modifications, equivalents, and alternatives falling within the spirit and scope of the various implementations described and the appended claims. Further, the disclosure herein of any particular feature, aspect, method, property, characteristic, quality, attribute, element, or the like in connection with an implementation or embodiment can be used in all other implementations or embodiments set forth herein. Any methods disclosed herein need not be performed in the order recited. The methods disclosed herein may include certain actions taken by a practitioner; however, the methods can also include any third-party instruction of those actions, either expressly or by implication. The ranges disclosed herein also encompass any and all overlap, sub-ranges, and combinations thereof. Language such as “up to,” “at least,” “greater than,” “less than,” “between,” and the like includes the number recited. Numbers preceded by a term such as “about” or “approximately” include the recited numbers and should be interpreted based on the circumstances (for example, as accurate as reasonably possible under the circumstances, for example ±5%, ±10%, ±15%, etc.). For example, “about 3.5 mm” includes “3.5 mm.” Phrases preceded by a term such as “substantially” include the recited phrase and should be interpreted based on the circumstances (for example, as much as reasonably possible under the circumstances). For example, “substantially constant” includes “constant.” Unless stated otherwise, all measurements are at standard conditions including temperature and pressure.

As used herein, a phrase referring to “at least one of” a list of items refers to any combination of those items, including single members. As an example, “at least one of: A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain embodiments require at least one of X, at least one of Y, and at least one of Z to each be present. The headings provided herein, if any, are for convenience only and do not necessarily affect the scope or meaning of the devices and methods disclosed herein.

Accordingly, the claims are not intended to be limited to the embodiments shown herein but are to be accorded the widest scope consistent with this disclosure, the principles and the novel features disclosed herein.

What is claimed is:

1. A method for regression fitting comprising:
receiving, by a computing system, a dataset corresponding to a diagnostic test;
receiving, by the computing system, one or more regression fitting parameters comprising a kernel;
determining, by the computing system, an initial regression;
calculating, by the computing system using a kernel, a plurality of local statistics of the dataset, the local statistics determined at least in part based on the one or more regression fitting parameters;
determining, by the computing system, a plurality of envelopes, the plurality of envelopes based at least in part on the one or more regression fitting parameters and the plurality of local statistics;
excluding, by the computing system, one or more data points of the dataset that are outside the plurality of envelopes;
determining, by the computing system, a second regression based on the dataset, wherein the second regression excludes the one or more data points that are outside the plurality of envelopes.

2. The method of claim 1, wherein the dataset comprises retinal nerve fiber layer thickness data.

3. The method of claim 2, further comprising:
determining a rate of change of the retinal nerve fiber layer.

4. The method of claim 1, wherein the dataset comprises intraocular pressure data.

5. The method of claim 1, wherein the dataset comprises visual field data.

6. The method of claim 1, wherein the kernel is a compact kernel.

7. The method of claim 1, wherein the kernel is a non-compact kernel.

8. The method of claim 1, wherein the one or more regression fitting parameters comprise a window size, and wherein the local statistics comprise a variance for each window of a plurality of windows.

9. The method of claim 8, wherein the window size comprises a number of days.

10. The method of claim 8, wherein the window size comprises a number of visits.

11. The method of claim 1, further comprising:
before receiving the dataset corresponding to a diagnostic test, receiving at least one optical coherence tomography image;
determining, using an image classification image, a quality of each of the at least one optical coherence tomography image; and
determining, using a feature extraction engine, a retinal nerve fiber layer thickness associated with each of the at least one optical coherence tomography image.

12. A system for regression fitting comprising:
a computer readable storage medium having program instructions embodied therewith; and
one or more processors configured to execute the program instructions to cause the system to:
receive a dataset corresponding to a diagnostic test;
receive one or more regression fitting parameters;
determine an initial regression;
calculate, using a kernel, a plurality of local statistics of the dataset, the local statistics determined at least in part based on the one or more regression fitting parameters;
determine a plurality of envelopes, the plurality of envelopes based at least in part on the one or more regression fitting parameters and the plurality of local statistics;
exclude one or more data points of the dataset that are outside the plurality of envelopes;
determine a second regression based on the dataset, wherein the second regression excludes the one or more data points that are outside the plurality of envelopes.

13. The system of claim 12, wherein the dataset comprises retinal nerve fiber layer thickness data.

14. The system of claim 13, wherein the instructions are further configured to cause the system to determine a rate of change of the retinal nerve fiber layer.

15. The system of claim 12, wherein the kernel is a compact kernel.

16. The system of claim 12, wherein the kernel is a non-compact kernel.

17. The system of claim 12, wherein the one or more regression fitting parameters comprise a window size, and wherein the local statistics comprise a variance for each window of a plurality of windows.

18. The system of claim 17, wherein the window size comprises a number of days.

19. The system of claim 17, wherein the window size comprises a number of visits.

20. The system of claim 12, wherein the instructions are further configured to cause the system to:
before receiving the dataset corresponding to a diagnostic test, receive at least one optical coherence tomography image;
determine, using an image classification image, a quality of each of the at least one optical coherence tomography image; and
determine, using a feature extraction engine, a retinal nerve fiber layer thickness associated with each of the at least one optical coherence tomography image.
